(19) United States
(12) Patent Application Publication
(10) Pub. No.: US 2018/0270247 A1
(43) Pub. Date: Sep. 20, 2018

(54) Information Sharing Program, Information Processing Device, And Information Sharing Method

(71) Applicant: Tetsuya WADA, Osaka (JP)

(72) Inventor: Tetsuya WADA, Osaka (JP)

(21) Appl. No.: 15/570,708

(22) PCT Filed: Apr. 27, 2016
(86) PCT No.: PCT/JP2016/063269

§ 371 Date: Oct. 30, 2017

(30) Foreign Application Priority Data
Apr. 30, 2015 (JP) 2015-092534

(51) Int. Cl. H04L 29/06; G06Q 10/10; G06Q 10/06; G06F 21/62; H04L 12/58

(52) U.S. Cl. CPC H04L 63/104; G06Q 10/1097; H04L 51/22; G06Q 10/107; G06F 21/6245; G06Q 10/063114

(57) ABSTRACT

The present invention provides an information sharing program, an information processing device, and an information sharing method which enable selection of sharing target information and information sharing members, and enable an interaction between the sharing members to share necessary information and reduce an external leakage risk. An information processing device 10 is configured by installing an information sharing program in a server. The information processing device 10 includes an external mail communication processing unit 20, a sharing target information specifying processing unit 42, a sharing target person selection processing unit 44, a comment creation processing unit 46, and an internal information processing unit 47.

### TECHNICAL FIELD

The present invention relates to an information sharing program, an information processing device, and an information sharing method which share private communication information such as specific electronic mails between a plurality of people and realize interactions and task management by using these electronic mails as a hub.

### BACKGROUND ART

In recent years, with the development of the Internet, information transmission means such as in-house communication and exchange of information with clients in corporate activities mainly uses electronic mails. Regarding communication in a department in a company, information is also transmitted from a manager to department members by using electronic mails.

Electronic mails such as mails related to business requests from clients and mails related to communication matters in companies are often task starting points. It is desirable that all of the related members share these information contents and respond to these electronic mails. Hence, electronic mails from clients are forwarded to related members, and are sent to a plurality of members by CC (Carbon Copy), or BCC (Blind carbon copy) and the like. In order to provide convenience under such circumstances, a program which shares electronic mails and a system which shares electronic mails are provided.

In the electronic mail sharing system of Patent Literature 1, when a specific electronic mail reception address is provided and an electronic mail sent to this electronic mail reception address as an address is received, a bulletin board which can be browsed by specific members in a company is displayed. A specific member creates a comment on the bulletin board and other members browse the bulletin board to share electronic mail information sent from a client, and manage a task progress such as a maintenance response.

### CITATIONS LIST

Patent Literature 1: Unexamined Japanese Patent Publication No. 2005-84844

### SUMMARY OF INVENTION

### Technical Problems

When receiving electronic mails with specific electronic mail addresses set as addresses, the electronic mail sharing system of Patent Literature 1 creates a bulletin board for sharing these electronic mail contents. However, it is not always efficient to share all pieces of information addressed to these specific electronic mail addresses. That is, it is assumed that there is inappropriate information among pieces of information that are sharing target candidates to share, and it is desirable to appropriately select and share information from these pieces of information. When these pieces of information are shared between a plurality of members more than necessary, even if the information is shared among members in the same company, the risk of unintentional leakage of information is high. Therefore, it is desirable to share these pieces of information between requisite minimum members. However, the electronic mail sharing system of Patent Literature 1 cannot specify sharing information and select members to share, and therefore has difficulty in responding to the risk of information leakage from in-house members as described above.

It is therefore an object of the present invention to provide an information sharing program, an information processing device, and an information sharing method which enable selection of sharing target internal information and internal information sharing members, enable an interaction such as creation of comments related to internal information between the sharing members to share necessary information and reduce an external leakage risk.

### Solutions to Problems

An information sharing program according to the present invention provided to solve the above problem causes an information processing device to realize: a private communication information processing function of designating a specific user as a management user, configuring an information sharing group by users including one or a plurality of managed users other than the management user, and the management user, and enabling information to be shared in the information sharing group, the information including private communication information exchanged between the management user and an outsider outside the information sharing group, and processing the private communication information; a sharing target information specifying function of enabling specification of one or a plurality of pieces of information selected from the private communication information as sharing target information; a sharing target person registering function of enabling registration of the managed user configuring the information sharing group as a sharing target person; a comment creating function of enabling creation of a comment associated with the sharing target information; and an internal information sharing processing function of enabling only a user to browse internal information including the sharing target information and the comment, the user configuring the information sharing group.

According to the information sharing program of the present invention, it is possible to select and appropriately share requisite minimum private communication information among the private communication information such as an electronic mail. Further, these pieces of information can be shared among requisite minimum members. Consequently, it is possible to expect a decrease in the risk of leakage of internal information from in-house members. Further, the information sharing program according to the present invention enables a sharing target person to create a comment on private communication information specified as a sharing target. By this means, it is possible to activate communication related to sharing target information among information sharing members.

Here, it is concerned that, when the private communication information is an electronic mail and when CC and forwarding functions of electronic mails are employed for the purpose of sharing information of internal information with sharing target persons, mails are erroneously sent by mistake to wrong addresses. As described above, according to the information sharing program of the present invention, internal information can be shared among sharing target persons without CC or forwarding. Consequently, it is possible to suppress problems such as the leakage of internal information such as an electronic mail to an outside of a company due to erroneous input of an address. At the same time, it is possible to avoid multiple times of transmission of multiple electronic mails in response to one electronic mail by way of CC, forwarding and reply. Consequently, it is possible to suppress a problem of an overflow of these sent and received mails in a mailbox.

According to the above configuration, it is possible to select private communication information which needs to be shared as a sharing target and select a sharing target person from internal members for each sharing target mail. Therefore, it is possible to flexibly and appropriately select sharing members per sharing target mail which is a task starting point. Consequently, it is possible to avoid problems that unnecessary information is shared and information leaks to unnecessary members.

Recent corporate activities take a long period of time from the occurrence to completion of one task. It is assumed that it is necessary to add members to share information with, and a task executor is excluded from task execution due to transfer or retirement until completion of the task. In order to respond to such a situation, it is desirable that members who share internal information can be flexibly changed even in a task execution process.

In order to respond to the above problem, according to the information sharing program, the managed user configuring the information sharing group can be desirably added and deleted per sharing target information.

According to the above configuration, it is possible to add and exclude members with who internal information needs to be shared at timing when the internal information needs to be shared. Consequently, when it is necessary to change a member who executes a task in the task execution process, it is possible to change the sharing member. As a result, a task manager can always share information with appropriate members, and it is possible to avoid leakage of internal information to members who are excluded from sharing target persons. On the other hand, for members who are excluded from sharing targets, information which is related to tasks and does not need to be prosecuted is not added. As a result, it is possible to further suppress a problem that unnecessary internal information is displayed and the private communication information overflows in a mail box.

As described above, information is mainly transmitted by using electronic mail in recent years, and private communication information such as these electronic mails is the task starting point in many cases. In this way, when private communication information which is a task starting point is received, and information is shared as sharing target information between a plurality of members, there is a problem that who responsibly leads execution of the task becomes ambiguous. Further, it is assumed that a task completion deadline which indicates until when to complete the task also becomes ambiguous, and the task management becomes complicated.

In order to respond to the above problem, the information sharing system according to the present invention may further cause the information processing device to realize: a task setting function of setting a task related to the internal information or the private communication information; and a task executor selecting function of enabling selection of a task executor who executes the task.

By selecting and displaying the task executor, who responsibly executes a task related to internal information becomes clear, and it is possible to avoid a problem that task execution delays. Consequently, it is expected that the task executor feels actively executes the task responsibly. Further, depending on whether or not a task relates to the task which is accepted by a user herself or himself among sharing target persons, it is possible to prioritize and execute these tasks.

Furthermore, in order to respond to the above problem of task completion deadline, the information sharing system according to the present invention may further cause the information processing device to realize a task completion deadline setting function of enabling setting of a completion deadline of the task.

According to the above configuration, the task completion deadline becomes clear, so that it is easy to grasp a progress related to the task such as until when the task manager and the task executor need to complete the task which is being executed.

Further, the task completion deadline setting function may enable setting of a completion deadline of the task based on information extracted under a predetermined condition based on the internal information related to the task.

According to the above configuration, it is possible to save time and effort for setting the deadline of the task completion deadline.

The information sharing program according to the present invention may further cause the information processing device to realize a task progress status tallying function of tallying a completion deadline set to the task set to the task executor and tallying a progress status of the task.

According to the above configuration, task contents and deadline indicating who, what, until when and how many tasks are accepted and executed become obvious. Consequently, it is easy for the task manager to grasp the entire operation. Also, by grasping the number of tasks assigned to each member, it is possible to appropriately assign tasks.

The information sharing program according to the present invention may further cause the information processing device to realize an information transmission restricting function of restricting transmission of the private communication information from the managed user to the outsider outside the information sharing group.

According to such a configuration, it is possible to suppress a situation that, for example, a user (approval target person) who is unfamiliar with an operation transmits private communication information of contents which an operation manager does not assume, or private communication information of an uncompleted text.

The information sharing program according to the present invention may further cause the information processing device to realize an approving function of deactivating restriction of transmission of part or all of the private communication information whose transmission has been restricted by the information transmission restricting function.

According to such a configuration, there is the private communication information which has been created by the managed user yet whose transmission has been restricted by the information transmission restricting function. A piece of information among this private communication information which a management user has decided to transmit as is, the approving function may function to deactivate transmission restriction and transmit the information as is to an outsider. Consequently, it is possible to further simplify an operation of transmitting private communication information.

The information sharing program desirably causes the information processing device to realize a thread creating function of enabling selection of the sharing target person per the sharing target information, and displaying the sharing target information and the comment associated with the sharing target information in the internal information collectively in a single thread.

According to the above configuration, it is possible to more flexibly select sharing target information and share information between requisite minimum members per selected sharing information. Further, by displaying information related to one of these pieces of sharing target information collectively as a thread, it is possible to browse related internal information at a time. That is, a thread per task is displayed based on the private communication information such as one electronic mail as the task starting point, so that it is possible to further improve convenience.

In the present invention and the following description, the “thread” collects and displays private communication information and comments related to a single topic to be browsed. For example, collection of sharing target mails and comments on the sharing target mails which can be collectively browsed at a time corresponds to a thread.

According to the information sharing program of the present invention, the internal information and the private communication information are desirably displayed in an identical user interface.

According to the above configuration, it is possible to handle private communication information such as electronic mails and internal information likewise, and it is possible to manage the private communication information and internal information in a unified manner. As a result, it is possible to simultaneously check private communication information such as electronic mails and check internal information, and expect a decrease in unchecked internal information and the like.

According to the information sharing program of the present invention, electronic mail communication information related to communication of the electronic mail may be included in the private communication information, and the electronic mail may be handled as part or all of the private communication information.

According to the above configuration, each user can exchange private communication information and effectively use the internal information.

The information sharing program according to the present invention may include a read function of enabling decision as to which member of sharing target persons with who sharing target information is shared has checked contents of sharing target information. As a result, it is possible to encourage the sharing target person who has not yet checked important sharing target information to quickly check information.

The information sharing method according to the present invention causes an electronic mail transmitting/receiving device to execute the above information sharing program.

The information processing device according to the present invention makes the above information sharing program function.

The information sharing method and information processing device according to the present invention can efficiently share private communication information such as electronic mails which are task starting points between necessary members and contribute to efficient task execution.

### Advantageous Effects of Invention

The present invention can provide an information sharing program, an information processing device, and an information sharing method which enable selection of sharing target internal information and internal information sharing members, enable exchange such as creation of comments related to internal information between the information sharing members to share necessary information and risk reduction of an external leakage of information.

### BRIEF DESCRIPTION OF THE DRAWINGS

FIG. 1 is an explanatory diagram illustrating an outline of an information processing device and an information sharing method realized by using an information sharing program according to one embodiment of the present invention.

FIG. 2 is a block diagram illustrating a configuration of the information processing device illustrated in FIG. 1.

FIG. 3 is a schematic diagram illustrating that the information processing device illustrated in FIG. 1 is used to share an electronic mail among sharing target persons.

FIG. 4 is a flowchart illustrating an example of a sharing target mail processing operation of the information processing device illustrated in FIG. 1.

FIG. 5 is a flowchart illustrating an example of a task request and task completion deadline processing operation of the information processing device illustrated in FIG. 1.

FIG. 6 is a flowchart illustrating an example of an approval request processing operation of the information processing device illustrated in FIG. 1.

FIG. 7 is an image view illustrating an example of a state where a received electronic mail is displayed on a top screen displayed on a browser of a terminal device by display processing of the information processing device illustrated in FIG. 1.

FIG. 8 is an image view illustrating an example of a state where a thread is displayed on the top screen displayed on the browser of the terminal device by the display processing of the information processing device illustrated in FIG. 1.

FIG. 9 is an image view illustrating an approval request screen displayed by executing an information sharing program according to one example of the present invention.

FIG. 10 is an image view illustrating a task progress status management screen displayed by executing the information sharing program according to one example of the present invention.

### DESCRIPTION OF EMBODIMENT

Hereinafter, an information sharing program, an information processing device 10, and an information sharing method according to one embodiment of the present invention will be described in detail with reference to the drawings.

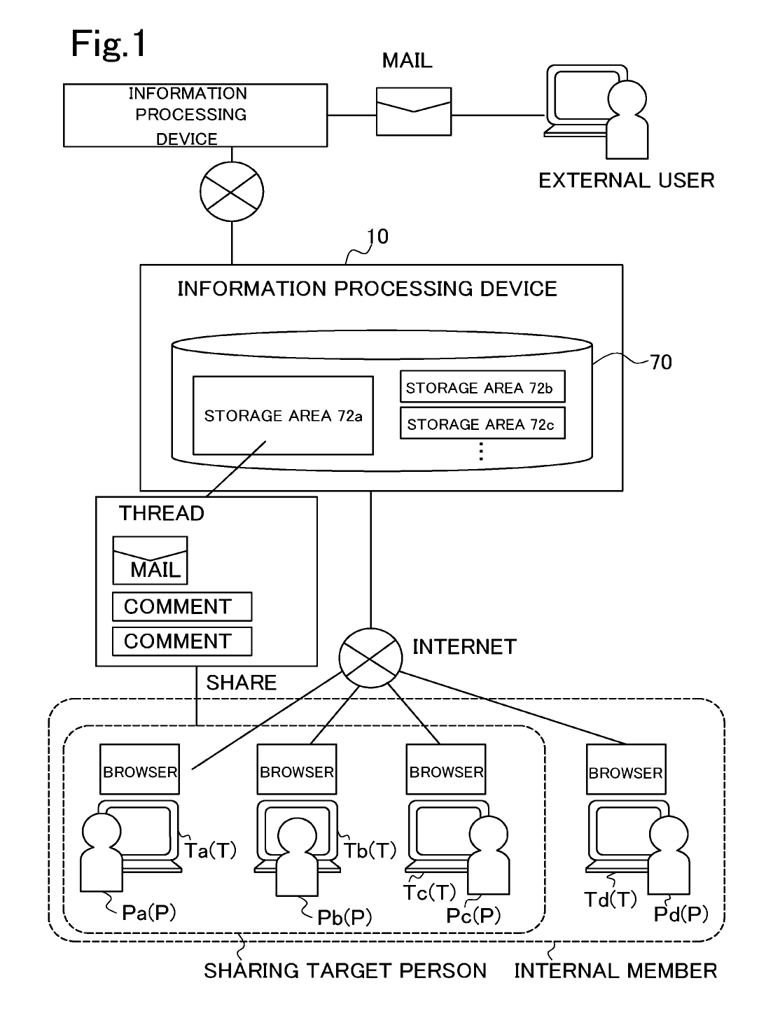

As illustrated in FIG. 1, the information processing device 10 executes the information sharing program according to the present invention. The present embodiment describes communication which uses electronic mails as an example of private communication information. The information sharing program according to the present embodiment has a function as so-called WEB mail software, and causes the information processing device 10 to execute this function.

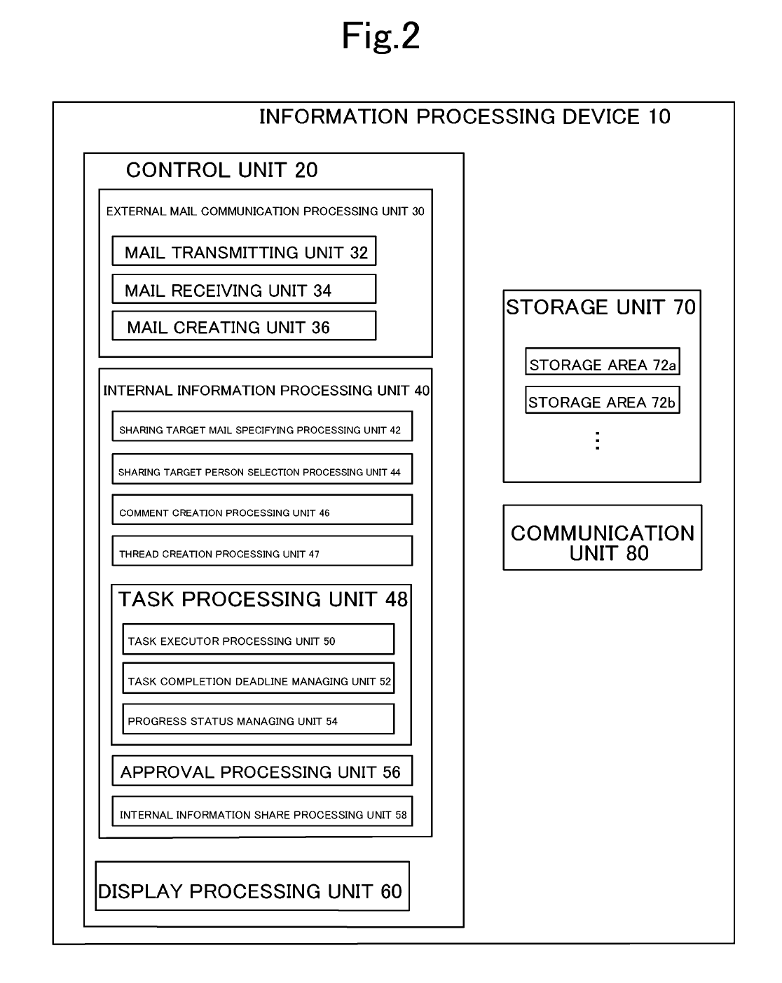

The information processing device 10 has a function as a so-called WEB server, and performs electronic mail communication with other information processing devices via a network and transmission and reception of electronic mails to and from a terminal device T. The information processing device 10 is connected to a communication network such as an Internet network, a local area network (LAN), a wide area network (WAN), or a virtual private network (VPN) and can perform communication. By installing the information sharing according to the present invention in the information processing device 10, a basic configuration illustrated in FIG. 2 is constructed. Further, the information processing device 10 causes the terminal device T to display a predetermined interface related to transmission and reception of electronic mails via a browser. A user P who uses the terminal device T connects the terminal device T to the Internet and uses the information sharing program installed in the information processing device 10 via the browser displayed on the terminal device T.

FIG. 2 is a block diagram illustrating an example of a functional configuration of the information processing device 10. As illustrated in FIG. 2, the information processing device 10 includes a control unit 20, a storage unit 70, and a communication unit 80. In the control unit 20, an external mail communication processing unit 30, an internal information processing unit 40, and a display processing unit 60 are constructed. The storage unit 70 includes a storage area 72 in which electronic mail information of each user P is stored. In the storage area 72, information such as external mails and internal information described in detail later are stored in the storage area 72 per user P. The communication unit 80 exchanges various pieces of information through the network.

The terminal device T displays a predetermined user interface displayed by the information processing device 10 on a monitor (not illustrated) which is an output device. When the user P makes an input to an input device (not illustrated) such as a mouse or a keyboard of the terminal device T, these inputs are input to the information processing device 10 via the network.

As illustrated in FIG. 1, users Pa, Pb, Pc, Pd and . . . are internal members who configure the same group. The terminal devices Ta, Tb, Tc, Td, and . . . used by the users Pa, Pb, Pc, Pd . . . are connected to the information processing device 10 via a predetermined network.

The external mail communication processing unit 30 performs processing related to transmission and reception (external mail) of an electronic mail which is private communication information of each of the users Pa, Pb, Pc, Pd and . . . . The external mail communication processing unit 30 employs the same configuration as conventionally known WEB mail software. More specifically, the external mail communication processing unit 30 includes a mail transmitting unit 32, a mail receiving unit 34, and a mail creating unit 36 and the like. The mail transmitting unit 32 performs information processing of sending electronic mails. The mail receiving unit 34 performs information processing of receiving electronic mails. The mail creating unit 36 realizes an electronic mail creating function. Transmitted and received electronic mails processed in the external mail communication processing unit 30 and data related to an electronic mail which is being created are processed to be able to be displayed by a predetermined user interface in the display processing unit 60 described in detail later, and stored in a predetermined area in the storage unit 70.

The internal information processing unit 40 includes each function of appropriately and effectively sharing internal information. Specifically, the internal information processing unit 40 includes a sharing target mail specifying processing unit 42, a sharing target person selection processing unit 44, a comment creation processing unit 46, a thread creation processing unit 47, a task processing unit 48, an approval processing unit 56, and an internal information processing unit 58. Each component will be more specifically described below.

Among electronic mails (external mails) which are private communication information of the user P received by the mail receiving unit 34, the sharing target mail specifying processing unit 42 processes as a sharing target mail an electronic mail specified as the sharing target with other internal members by the user P (also referred to as a “management user A” below) who is the manager of this mail. The external mail (sharing target mail) specified as the sharing target by the sharing target mail specifying processing unit 42 is stored in the storage area 72 in which the electronic mail addressed to the management user A is stored.

The sharing target person selection processing unit 44 is provided to exhibit a function (sharing target person registering function) of selecting and registering a target person with who a sharing target mail and a comment (internal information) related to this sharing target mail selected by the management user A as a sharing target are shared. More specifically, in case of a mail of the user Pa who is the management user A, a mail selected by the user Pa from a personal mail of the user Pa (the mail addressed to the user Pa or the mail sent by the user Pa) is the sharing target mail. Further, when the management user A is the user Pa, the other users Pb, Pc, Pd, and . . . (also referred to as “managed users p” below) are sharing target person candidates. In this case, the user Pa who is the management user A can use the sharing target person selection processing unit 44 to select a sharing target person from the users (internal members) Pb, Pc, Pd, and . . . of the terminal devices T connected to a predetermined network. The user P (managed user p) selected as the sharing target person is allowed to access the sharing target mail stored in the storage area 72 of the management user A who is another person. As a result, the managed user p who is the sharing target person can check the internal information such as a sharing target mail stored in the storage area 72 of the management user A.

When the management user A changes members of the sharing target persons (managed users p) for the sharing target mail (internal information) whose sharing target persons (managed users p) are already set by the management user A, the sharing target person is reselected by an input to the sharing target person selection processing unit 44. In this case, the user who has been excluded as the sharing target person is prohibited from accessing the sharing target mail shared so far. Consequently, the managed user p who has been excluded as a sharing target person cannot browse internal information whose sharing has been canceled.

The comment creation processing unit 46 is provided for the user P (the management user A or the managed user p) to create a comment on a sharing target electronic mail and comments linked to the comment linked to the sharing target electronic mail.

The thread creation processing unit 47 is provided to process sharing target mails and comments linked to these sharing target mails as a single thread collectively. More specifically, when the sharing target mail is selected, the sharing target mail is processed as one thread and stored in the storage area 72 in which the information whose address and sender are the user P is stored. When the managed users p and the management user A who are the sharing target persons create comments related to electronic mails which configure the thread or the related comment, the comments are added to the thread stored in the above storage area 72. As a result, even when multiple comments are created for one thread, threads displayed in mailboxes of the user P and the sharing target persons are not added one after another. Consequently, it is possible to suppress the overflow of mails in the mailbox of the user P.

The task processing unit 48 includes various functions of promoting execution of tasks in which the sharing target mail selected and processed as a task starting point is a hub. The task processing unit 48 includes a task executor processing unit 50, a task completion deadline managing unit 52, and a progress status managing unit 54 which realize these functions.

The task executor processing unit 50 is provided to set as a task executor a person who executes a task related to an external mail or internal information selected by the management user A. The management user A can select a task executor from the managed user p who is the sharing target person as a person who executes a task related to the transmitted and received electronic mail (external mail) and internal information.

The task completion deadline managing unit 52 is provided to set a deadline for completing the task related to the external mails and the internal information. The deadline set to the task by the management user A is processed to be displayed together with the external mails and the internal information. Further, the task completion deadline managing unit 52 includes a function of extracting task completion deadline candidates from a text or a subject of the external mails or the internal information selected by the management user A. To extract the task completion deadline, task completion time candidates which satisfy a predetermined extraction condition are presented as task completion time candidates. As the extraction condition, for example, candidates which suggest a deadline such as “Please complete by what month and what day” or “the deadline is what month and what day” in the text of the electronic mail can be extracted and set. Further, the task completion deadline can be set at the same time as selection of the task executor described above. The task completion deadline information set by these deadline candidates is displayed together with internal information such as sharing target mails. Therefore, these pieces of information are also shared among the sharing target persons. Consequently, who and until when the task should be responsibly completed becomes clear, so that it is possible to contribute to execution of the task until the deadline.

The progress status managing unit 54 tallies and manages information indicating how many tasks have been accepted and completed per user P, and when is the completion deadline of the task which is being executed. A result tallied by the progress status managing unit 54 is displayed by the display processing unit 60, so that the user P can check the result via the browser displayed on the terminal device T.

When the managed user p creates a reply mail to outsiders other than the management user A and the managed users p, the approval processing unit 56 performs processing of approving transmission of the created reply mail. The information processing device 10 according to the present embodiment has a function (information transmission restricting function) of, even when the managed user p creates a reply mail to the electronic mail received from the outsider by the management user A, and the reply mail is not approved by the management user A, restricting transmission to the outsider. Therefore, the approval processing unit 56 includes a function of performing processing (approval processing) of approving the reply mail created by the managed user p and deactivating the information transmission restricting function.

The internal information processing unit 58 is provided to perform sharing processing in the above internal information processing unit 40. The internal information processing unit 58 performs processing of sharing information of electronic mails and internal information between a plurality of terminal devices T connected to the predetermined network. More specifically, the internal information processing unit 58 permits an access to predetermined internal information to a plurality of terminal devices T selected as sharing target persons. Consequently, even when exchange such as creation of a sharing target mail and a comment on this sharing target mail is performed in the terminal device T of the user P selected as a sharing target person, this information can be checked in the other terminal device T.

The display processing unit 60 is provided to perform processing of making it possible to display external mails and internal information processed in the external mail communication processing unit 30 and the internal information processing unit 40, on a predetermined user interface in the output device of the terminal device T. The display processing unit 60 can cause the browser displayed by the output device of the terminal device T of the user P to display the external mails and the internal information collectively in the same user interface.

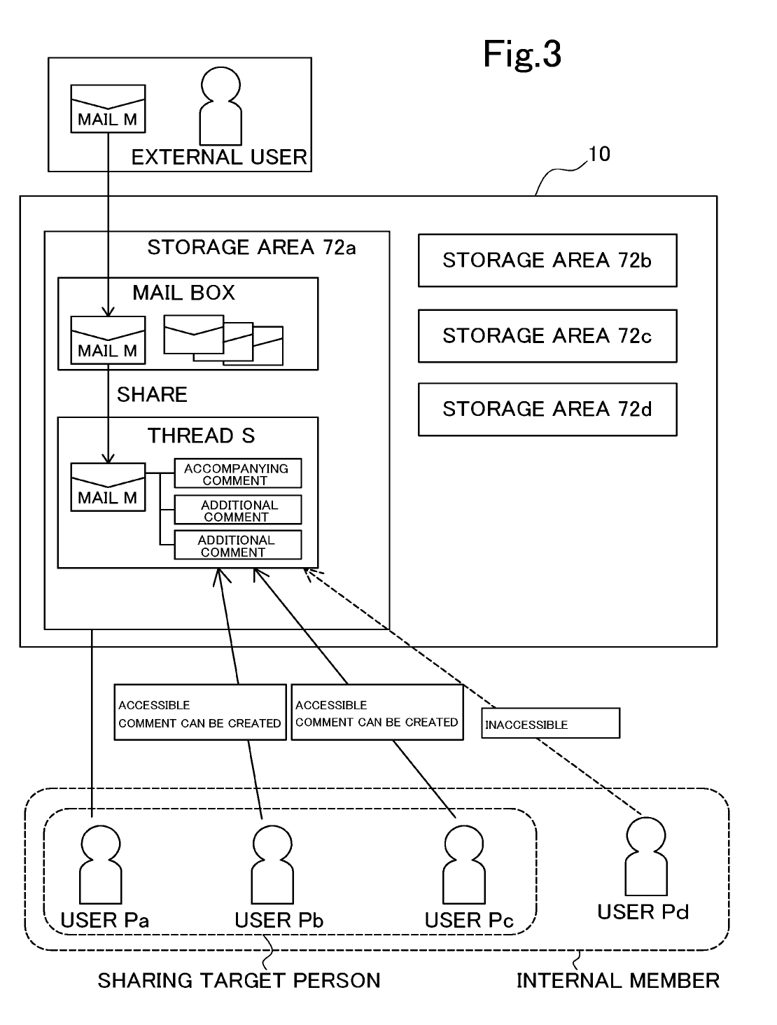

Next, a method for sharing electronic mails by using the information processing device 10 will be described in detail with reference to the drawings. In the following description, it is assumed that the user Pa is the management user A and the other users P such as the users Pb, Pc, and Pd are the managed users p. FIG. 3 is a schematic view illustrating that an electronic mail M transmitted from an external user to the user Pa is shared as a sharing target mail. A mail box of the user Pa is provided in a storage area 72a provided in the information processing device 10. That is, the electronic mail addressed to the user Pa and the electronic mail (external mail) sent by the user Pa are stored in the storage area 72a. When the user Pa specifies the electronic mail M as the sharing target mail, the user Pa becomes the management user A, and the other users Pb, Pc, and Pd who are internal members become managed users p candidates. Further, the electronic mail M and an accompanying comment created by the user Pa on the electronic mail M can be stored as one thread in the storage area 72a.

When the user Pa who is the management user A selects the users Pb and Pc of the internal members as the managed users p and tries to share the electronic mail M with the users Pb and Pc, i.e., when the users Pb and Pc are selected as sharing target persons of the mail M, the users Pb and Pc are permitted to access the thread S. On the other hand, the user Pd who is the internal member who is not selected as a sharing target person cannot access the thread S. Further, the users Pa, Pb, and Pc who are the sharing target persons can create additional comments on the thread S. In this way, it is possible to select a sharing target mail (sharing target information) and the sharing target persons, and share information and perform communication between the sharing target persons in the thread S.

Further, the user Pa who is the management user A can add or exclude the sharing target person (managed users p) at any time even after selecting the users Pb and Pc as the sharing target persons. More specifically, it is possible to add the user Pd who is not a sharing target person at the present time as a supply target person, or to exclude one or all of the users Pb and Pc who are the sharing target persons at the present time from the supply target persons. Users who are excluded from the sharing target persons are excluded and then lose the right to access the mail M and comments configuring the thread S.

### <<Sharing Target Mail Sharing Procedure>>

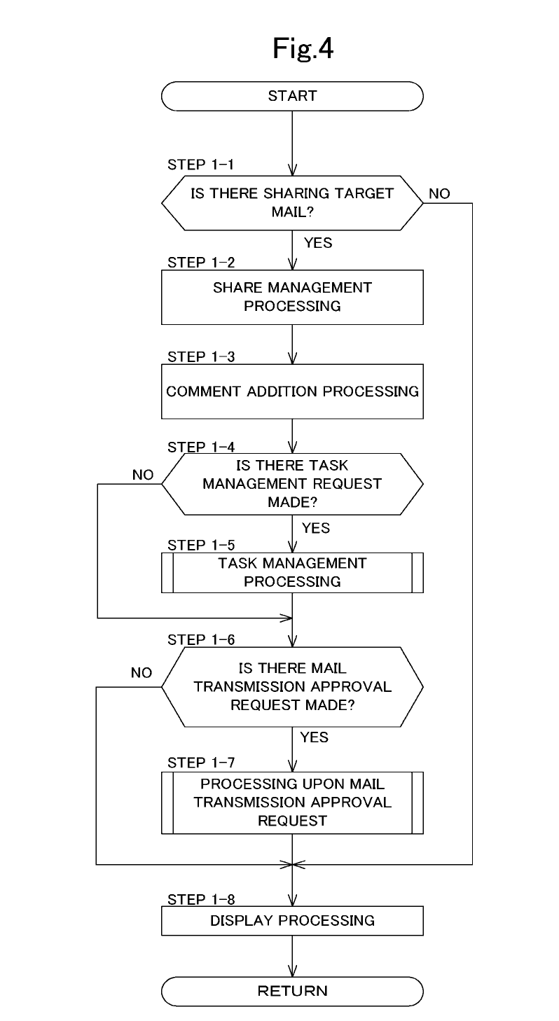

Subsequently, an overall procedure of specifying an electronic mail as a sharing target mail and displaying the sharing target mail as a thread in the information sharing method performed by the above information processing device 10 will be described in detail with reference to a flowchart of FIG. 4.

### (Step 1-1)

First, in step 1-1, whether or not processing of specifying the electronic mail (sharing target mail) which needs to be shared with the other users P from the electronic mail received by each user P has been performed is checked. When the sharing target mail is specified, a control flow moves to step 1-2. When the sharing target mail is specified, the processing of designating a user who is a recipient or a sender of the electronic mail as the management user A is performed.

### (Step 1-2)

In step 1-2, processing (sharing management processing) of sharing and managing the sharing target mail specified in step 1-1 by the management user A is performed. More specifically, processing of registering, as the managed users p, members with who the sharing target mail specified in step 1-1 and accompanying comments are shared, and processing of canceling the registration of the managed users p are performed. The members registered as the managed users can browse the sharing target mail and add and browse a comment linked to the sharing target mail. On the other hand, for members excluded from the managed users p, it is impossible to browse the sharing target mail, add the comment linked to the sharing target mail, and browse all. When sharing management processing is performed in step 1-2, the control flow then moves to step 1-3.

### (Step 1-3)

In step 1-3, processing (comment addition process) of adding a comment accompanying the sharing target mail is performed. The comment added by the comment addition processing is linked to the sharing target mail, and is handled as a comment which configures a single thread. When the comment addition processing is performed, the control flow moves to step 1-4.

### (Step 1-4)

In step 1-4, whether or not there is a request (task management request) for setting and managing a task related to the sharing target mail and the comment linked to the sharing target mail is decided. In this regard, when it is decided that the task management request has been made, the control flow moves to step 1-5. When it is decided that the task management request is not made, the control flow moves to step 1-8.

### (Step 1-5)

In step 1-5, the task management processing is performed according to the control flow related to a subroutine described in detail later. Thereafter, the control flow moves to step 1-8.

### (Step 1-6)

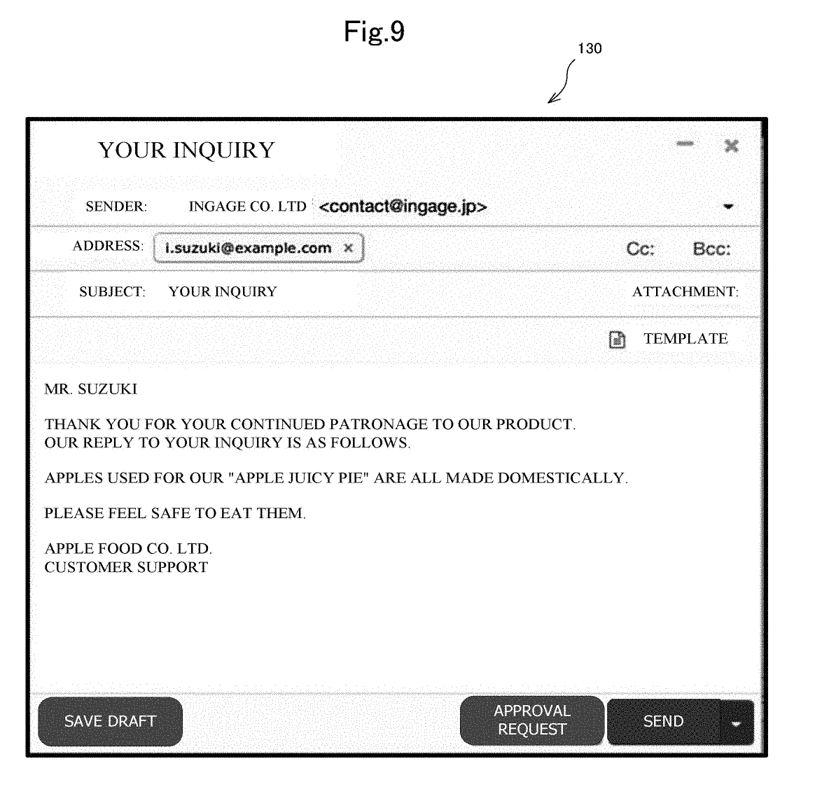

In step 1-6, a request (mail transmission approval request) for obtaining an approval for transmitting the mail (external transmission mail) prepared to transmit to the outsider by the managed user p is in an on state is checked. Here, in the present embodiment, when the managed user p creates an external transmission mail, a mail creation screen 130 for the managed user p illustrated in FIG. 9 is displayed. By clicking an approval request button 134 displayed on this mail creation screen 130, a mail transmission approval request is in the on state. When it is decided in step 1-6 that the mail transmission approval request is in the on state, the control flow moves to step 1-7. On the other hand, when it is decided in step 1-6 that the mail transmission approval request is in the off state, the control flow moves to step 1-8.

### (Step 1-7)

In step 1-7, processing (processing during a mail transmission approval request) of making a mail transmission approval request according to the control flow described later is performed. Thereafter, the control flow moves to step 1-8.

### (Step 1-8)

In step 1-8, information such as the sharing target mail and the comment processed in step 1-1 to step 1-5 is shared, and display processing of displaying these pieces of sharing information is performed by the display processing unit 60. As a result, a series of the control flow is completed.

### <<Task Management Processing>>

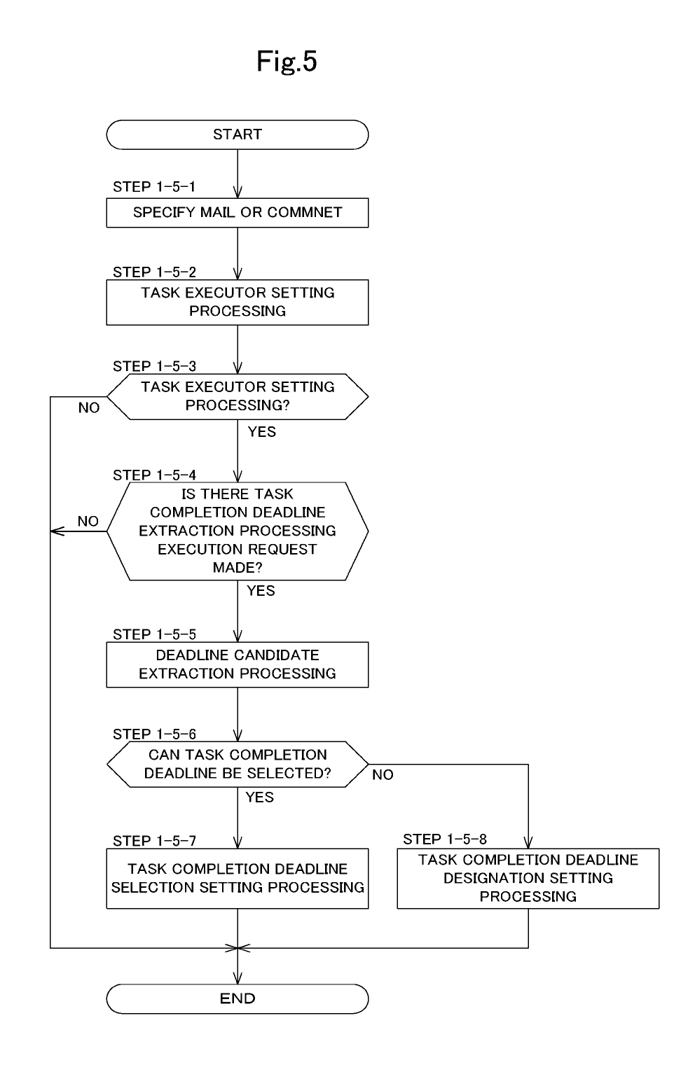

Next, the task management processing will be described with reference to the drawings. FIG. 5 illustrates a flowchart of the task management processing.

### (Step 1-5-1)

First, in step 1-5-1, the management user A specifies the electronic mail and the comment related to the task which needs to be managed. Thereafter, the control flow moves to step 1-5-2.

### (Step 1-5-2)

In step 1-5-2, processing (task executor setting processing) of setting a person who executes the task (task executor) based on selection of the management user A is performed. When the task executor setting processing is performed, the control flow moves to 1-5-3.

### (Step 1-5-3)

In step 1-5-3, whether or not it is necessary to set a completion deadline (task completion deadline) of the task to be set. When not to set the task completion deadline is selected, the control flow according to FIG. 5 is completed. On the other hand, when to set the task completion deadline is selected, the control flow moves to step 1-5-4.

### (Step 1-5-4)

In step 1-5-4, whether or not there is a request for execution of processing (task completion deadline extraction processing) of automatically extracting the task completion deadline from the electronic mail and the comment related to the task is checked. When there is a request to execute the task completion deadline extraction processing, the control flow moves to step 1-5-5. When there is no execution request, the control flow moves to step 1-5-8.

### (Step 1-5-5)

In step 1-5-5, processing (deadline candidate extraction processing) of extracting a description on a date and a time as the task completion deadline candidate from internal information or text data such as a text and a subject in the external mail is performed. When there are descriptions related to a plurality of dates and times, a plurality of task completion deadline candidates is extracted. After the task completion deadline candidates are extracted, the control flow moves to step 1-5-6.

### (Step 1-5-6)

In step 1-5-6, whether or not the user P can select the task completion deadline from the deadline candidates extracted as the task completion deadline candidates in step 1-5-5 is checked. When the user P can select the task completion deadline from the deadline candidates, the control flow moves to step 3-7.

### (Step 1-5-7)

In step 1-5-7, processing (completion deadline selection setting processing) of setting the task completion deadline selected by the management user A from the task completion candidates extracted in step 1-5-6 is performed. As a result, the series of the control flow related to FIG. 5 is completed.

### (Step 1-5-8)

In step 1-5-8, processing (completion deadline designation setting processing) of setting the date and the time designated by the management user A as the task completion deadline is performed. As a result, the series of the control flow related to FIG. 5 is completed.

### <<Processing Upon Mail Transmission Approval Request>>

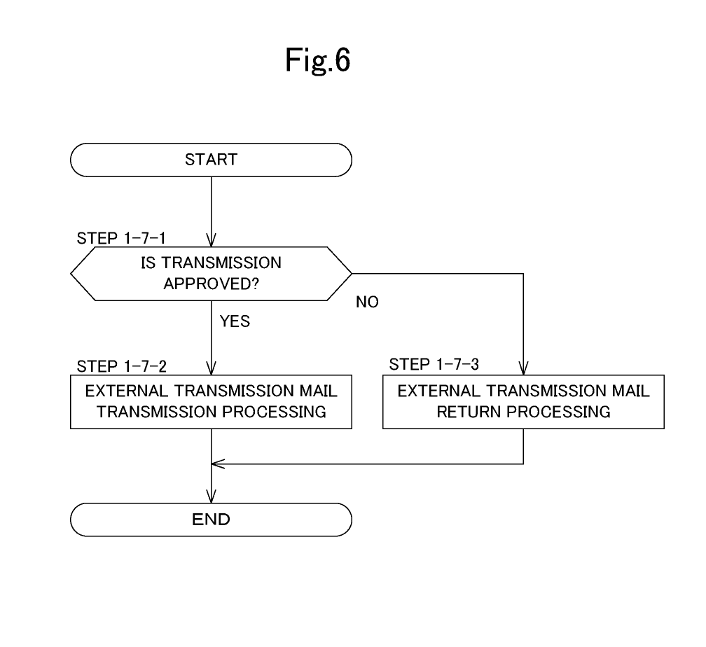

Next, processing upon a mail transmission approval request will be described in detail with reference to the drawings. FIG. 6 is a flowchart illustrating a flow of the processing upon the mail transmission approval request. Each procedure will be described in detail below.

### (Step 1-7-1)

In step 1-7-1, whether or not the external transmission mail created by the managed user p is approved by the management user A is checked. In this regard, when the external transmission mail is approved by the management user A, the control flow moves to step 1-7-2. On the other hand, when the external transmission mail is not approved by the management user A, the control flow moves to step 1-7-3.

### (Step 1-7-2)

In step 1-7-2, the mail transmitting unit 32 performs transmission processing of transmitting the external transmission mail whose transmission has been approved by the management user A. When the transmission processing is completed, the control flow illustrated in FIG. 6 is completed.

### (Step 1-7-3)

In step 1-7-3, processing (return processing) of returning the external transmission mail whose transmission has been rejected by the management user A to the managed user p who is the creator is performed. As a result, a series of the control flow illustrated in FIG. 6 is completed.

As described above, according to the information processing device 10 of the present embodiment, it is possible to share electronic mails transmitted from the outside in a predetermined group, and comments created on the electronic mails. That is, by using one electronic mail as a hub, it is possible to share comments exchanged inside between necessary members. For a task generated from one electronic mail, task management can be performed by using this electronic mail as a hub. Consequently, it is possible to contribute to efficient task execution, and further improve business efficiency and convenience.

In this regard, the present embodiment has described an example where data of an external mail and internal information is stored in the information processing device 10 which is a server on the network, and each terminal device T accesses the server through the Internet line and browses the data. However, the present invention is not limited to this. That is, the information sharing program according to the present invention can be installed in a server provided in a company, and the server can be caused to function as the information processing device 10. In this case, a network connected to the server (information processing device) and the terminal device T may use the Internet line or a local area network (LAN), too. When a LAN is used, a terminal device which is not connected to a predetermined LAN cannot check internal information. Consequently, it is possible to further prevent leakage of internal information to the outside.

Further, the information sharing program according to the present invention can be installed in the terminal device T, and the terminal device T can be caused to function as an information processing device, too.

The present embodiment has described an example where a personal computer is used for the terminal device T. However, a device capable of connecting the terminal device T to a predetermined network of a mobile phone or a smartphone can be used. Further, when an access is made to the information processing device 10 via the browser displayed on the terminal device T, user authentication such as input of a password may be requested.

In this regard, the present embodiment has described an example where an electronic mail is shared as an example of sharing target information in the same group. However, the present invention is not limited to this. More specifically, in place of the electronic mail or in addition to the electronic mail, electronic information in which an interaction with a specific other party by a telephone is recorded, and document or images created by using predetermined software can be employed as the sharing target information. Further, the internal information processing unit 40 may process the response record information of the above telephone.

### EXAMPLE

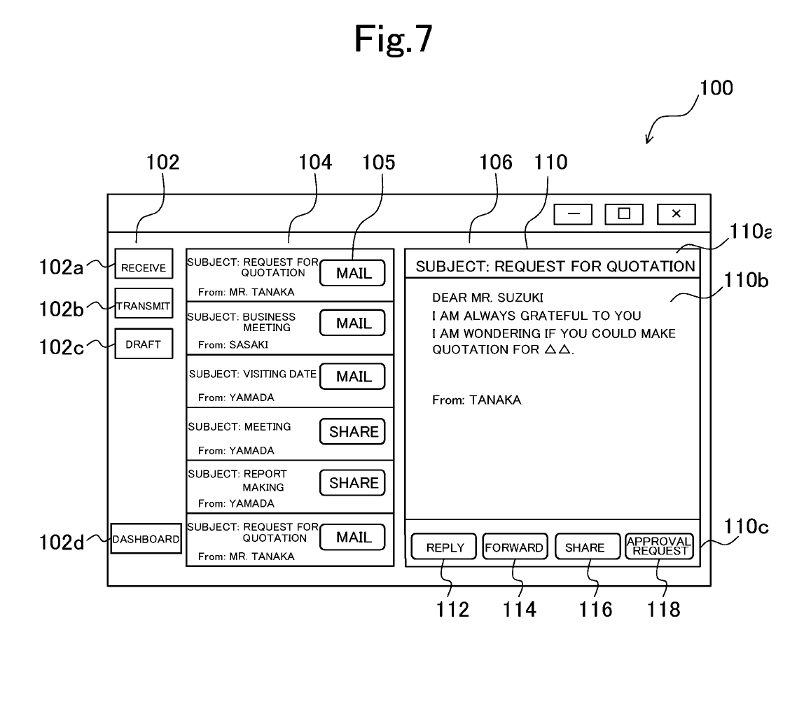

An example of the above-described information processing device 10 will be described with reference to FIGS. 7 to 10. FIG. 7 illustrates a user interface (also referred to as a “top screen 100” below) of an initial state where information stored in the storage area 72 of the information processing device 10 is displayed on a monitor which is an output device of the terminal device T. A display mode of the top screen 100 may be any mode. However, FIG. 7 illustrates an example of a so-called three-pane type interface including three regions of a left pane 102, a center pane 104, and a right pane 106. In the left pane 102 of the top screen 100, menu buttons of a reception tray button 102a, a transmitted tray button 102b, a draft tray button 102c, and a dashboard button 102d are displayed side by side in the vertical direction.

The center pane 104 is an area which displays a list of threads which are transmitted and received electronic mails and sharing target information. FIG. 7 illustrates an example of a state where the reception tray button 102a is selected. In the electronic mail or the thread displayed as the list in the center pane 104, an identification indication 105 which indicates a type indicating an external mail (electronic mail) or a thread is displayed. When the target information is an electronic mail (external mail), the identification indication 105 is displayed as a “mail”. When the target information is internal information such as a thread, the identification indication 105 is displayed as “shared”. When one in the list displayed on the center pane 104 is selected, contents of the selected electronic mail or the thread is displayed on the right pane 106.

FIG. 7 illustrates a state where an electronic mail (external mail) is selected from the list displayed in the center pane 104. As illustrated in FIG. 7, the contents of the selected electronic mail is displayed on the right pane 106. When the electronic mail (external mail) is selected, the contents of the electronic mail is displayed in an electronic mail display area 110 in the right pane 106. The electronic mail display area 110 includes a mail subject display area 110a which displays a subject of an electronic mail, a mail text display area 110b, and an operation button area 110c for performing various operations on the electronic mail. In the operation button area 110c, a reply button 112, a forward button 114, a sharing target specifying button 116, and an approval request button 118 are displayed. Both the reply button 112 and the forward button 114 are used to reply an electronic mail as an external mail. On the other hand, the sharing target specifying button 116 and the approval request button 118 are used to specify sharing target information. When the sharing target specifying button 116 and the approval request button 118 are selected, the electronic mail is processed as the sharing target mail described above as sharing target information.

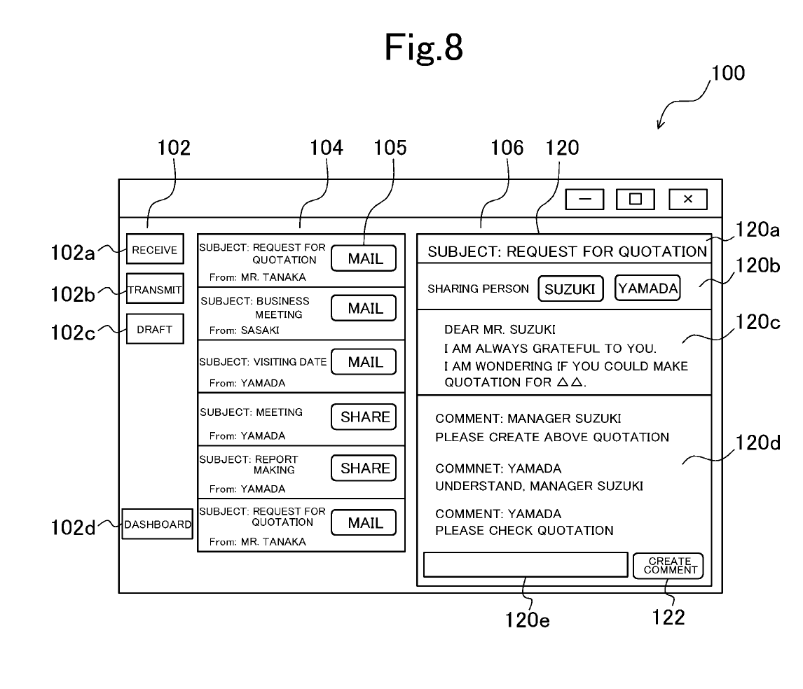

FIG. 8 illustrates a state where a thread (sharing target information) listed in the center pane 104 is selected. As illustrated in FIG. 8, when one thread is selected from the center pane 104, contents of the thread selected in the right pane 106 is displayed in a thread display area 120. The thread display area 120 includes a subject display area 120a, a sharing target person display area 120b, a sharing target mail display area 120c, a comment display area 120d, and a comment creation field 120e. In the sharing target person display area 120b, a list of sharing target persons who share a displayed sharing target mail is displayed as the list. Further, in the comment display area 120d, comments created for the sharing target mail are displayed in chronological order. Furthermore, the comment is inputted to the comment creation field 120e to create a comment on the sharing target mail.

FIG. 9 illustrates one example of a mail creation screen 130 created by an approval target person. As illustrated in FIG. 9, a draft save button 132, an approval request button 134, and a send button 136 are displayed in an area in which the mail creation screen 130 is displayed. When the approval request button 134 is selected, the transmission approval request is in the on state.

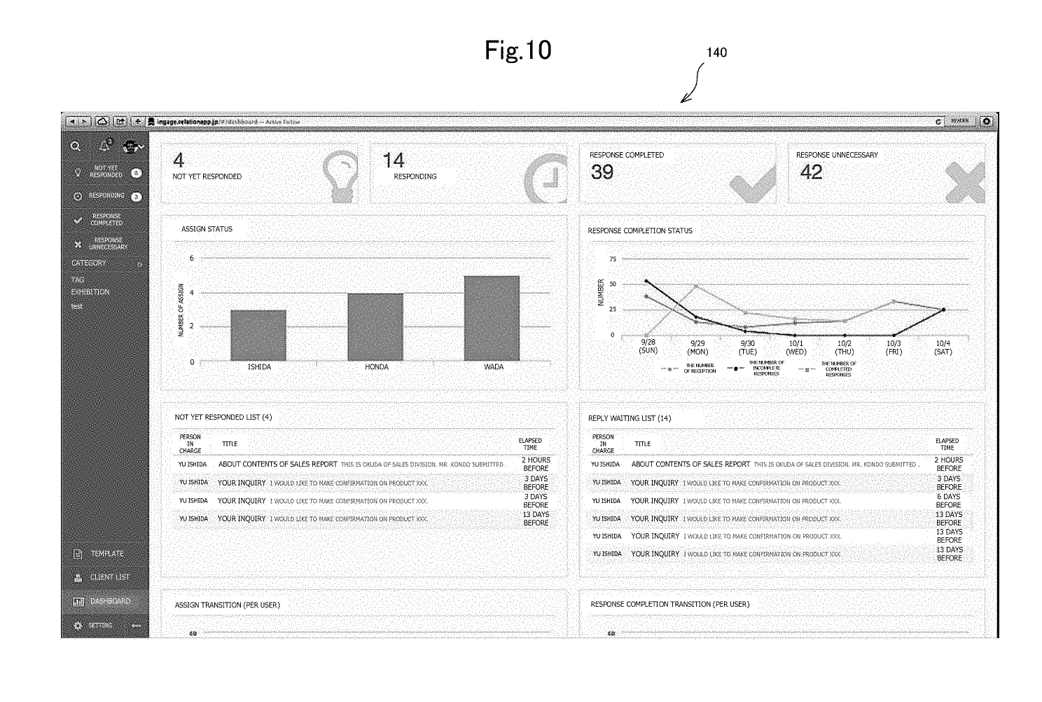

FIG. 10 illustrates a display example of a dashboard screen 140 of a task progress status list which is tallied by the progress status managing unit 54 of the information processing device 10. When the above-described dashboard button 102d is selected, the dashboard screen 140 illustrated in FIG. 10 is displayed. On the dashboard screen 140, it is possible to display information of task executors handled in the information processing device 10 and completion deadlines of these tasks as a list. More specifically, information such as a graph illustrating the number of accepted tasks per member and the number of support completed tasks, a list of tasks which are being executed, and a list of task completion deadlines which are being executed can be aggregated and displayed.

### INDUSTRIAL APPLICABILITY

The information sharing program, the information processing device, and the information sharing method according to the present invention are effectively used for a group in a company to respond to private communication information such as electronic mails transmitted from a client and execute tasks at fields such as a company's sales activity and customer support.

### REFERENCE SIGNS LIST

10 INFORMATION PROCESSING DEVICE
30 EXTERNAL MAIL COMMUNICATION PROCESSING UNIT
40 INTERNAL INFORMATION PROCESSING UNIT
42 SHARING TARGET MAIL SELECTION PROCESSING UNIT
44 SHARING TARGET PERSON SELECTION PROCESSING UNIT
46 COMMENT CREATION PROCESSING UNIT
47 THREAD CREATION PROCESSING UNIT
50 TASK EXECUTOR PROCESSING UNIT
52 TASK COMPLETION DEADLINE MANAGING UNIT
54 PROGRESS STATUS MANAGING UNIT
56 APPROVAL PROCESSING UNIT
58 INTERNAL INFORMATION PROCESSING UNIT
P USER

1. An information sharing program designating a specific user as a management user, configuring an information sharing group by users including one or a plurality of managed users other than the management user, and the management user, and enabling information to be shared in the information sharing group, the information including private communication information exchanged between the management user and an outsider outside the information sharing group and causing an information processing device to realize:
a private communication information processing function of processing the private communication information;
a sharing target information specifying function of enabling specification of one or a plurality of pieces of information selected from the private communication information as sharing target information;
a sharing target person registering function of enabling registration of the managed user configuring the information sharing group as a sharing target person;
a comment creating function of enabling creation of a comment associated with the sharing target information; and
an internal information sharing processing function of enabling only a user to browse internal information including the sharing target information and the comment, the user configuring the information sharing group.

2. The information sharing program according to claim 1, wherein the managed user configuring the information sharing group can be added and deleted per sharing target information.

3. The information sharing program according to claim 1, further causing the information processing device to realize:
a task setting function of setting a task related to the internal information or the private communication information; and
a task executor selecting function of enabling selection of a task executor who executes the task.

4. The information sharing program according to claim 3, further causing the information processing device to realize a task completion deadline setting function of enabling setting of a completion deadline of the task.

5. The information sharing program according to claim 4, wherein the task completion deadline setting function enables setting of a completion deadline of the task based on information extracted under a predetermined condition based on the internal information related to the task.

6. The information sharing program according to claim 3, further causing the information processing device to realize a task progress status tallying function of tallying a completion deadline set to the task set to the task executor and tallying a progress status of the task.

7. The information sharing program according to claim 1, further causing the information processing device to realize an information transmission restricting function of restricting transmission of the private communication information from the managed user to the outsider outside the information sharing group.

8. The information sharing program according to claim 7, further causing the information processing device to realize an approving function of deactivating restriction of transmission of part or all of the private communication information whose transmission has been restricted by the information transmission restricting function.

9. The information sharing program according to claim 1 enabling configuration of the information sharing group per sharing target information, further causing the information processing device to realize a thread creating function of displaying the sharing target information and the comment associated with the sharing target information in the internal information collectively in a single thread.

10. The information sharing program according to claim 1, wherein the internal information and the private communication information are displayed in an identical user interface.

11. The information sharing program according to claim 1, wherein
electronic mail communication information related to communication of the electronic mail is included in the private communication information, and
the electronic mail is handled as part or all of the private communication information.

12. An information sharing method comprising causing an information processing device to execute the information sharing program according to claim 1.

13. An information processing device which executes the information sharing program according to claim 1.
